(19) United States
(12) Patent Application Publication
(10) Pub. No.: US 2020/0034825 A1
(43) Pub. Date: Jan. 30, 2020

(54) ENHANCED SECURITY TRANSACTION CARD PRODUCT AND TWO-STAGE METHOD OF ACTIVATION

(71) Applicant: TARGET BRANDS, INC., Minneapolis, MN (US)

(72) Inventors: Matthew LEVY, Chanhassen, MN (US); Jaime Jorgensen, Lakeville, MN (US); Christine Laursen, Minnetonka, MN (US); Hope Chu, Edina, MN (US); Katie Larson, St. Louis Park, MN (US)

(73) Assignee: TARGET BRANDS, INC., Minneapolis, MN (US)

(21) Appl. No.: 16/520,575

(22) Filed: Jul. 24, 2019

Related U.S. Application Data
(60) Provisional application No. 62/702,745, filed on Jul. 24, 2018.

(51) Int. Cl. G06Q 20/34; G07F 7/08; B65D 73/00; G06Q 20/36

(52) U.S. Cl. CPC G06Q 20/354; G07F 7/0813; G06Q 20/363; G06Q 20/342; B65D 73/0092

(57) ABSTRACT

A transaction card product comprising a transaction card, an account identifier, a security panel, and an activation code. The account identifier uniquely links the transaction card to a remote account having a balance value available for redemption toward one or more of goods or services. The security panel is coupled to the transaction card and substantially entirely covers the account identifier. The security panel is configured to be at least partially removed from a remainder of the transaction card product to permit access to the account identifier. The activation code has data therein to prompt a point-of-sale terminal to begin a transaction card activation process, the activation code having a first portion directly secured to and extending over the security panel, wherein the activation code is characterized by an absence of any data directly identifying the remote account.

### CROSS-REFERENCE TO RELATED APPLICATION

This application is a non-provisional application of and claims priority under 35 U.S.C. § 119 to U.S. Provisional Patent Application No. 62/702,745, filed Jul. 24, 2018, which is incorporated herein by reference.

### BACKGROUND OF THE INVENTION

Stored-value cards, such as debit cards, gift cards, and telephone cards, and other transaction cards remain a popular means for maintaining and/or gifting monetary or other value. A gift card, for example, is a type of stored-value card includes a pre-loaded or selectively loaded monetary value or balance. The gift card is typically activated at a point-of-sale (POS) terminal, which readies the card for use by the consumer or other associated party. The balance associated with the gift card declines as the gift card is used, encouraging repeat visits to the retailer or other provider issuing the gift card. Additionally, the gift card generally remains in the user's purse or wallet, serving as an advertisement or reminder to revisit the associated retailer. In one example, the gift card or other transaction card can be re-loaded with additional value after the initial activation. Gift cards and other transaction card products provide a number of advantages to both the consumer and the retailer.

Transaction cards are often packaged and/or otherwise placed in a retail environment for sale while in an inactivated state. Transaction cards are brought to a point-of-sale (POS) terminal for processing and activation. Card activation typically includes reading an account identifier, such as a machine-readable code, number, etc., from the transaction card and/or the packaging associated therewith, correlating the account identifier with a remote account or record having a balance of monetary or other funds for the corresponding transaction card, and activating access to the balance of funds using the transaction card.

The sustained popularity of transaction cards and the values associated therewith have made transaction cards a target for tampering and/or other fraud. In one example, third parties modify or otherwise tamper with account identifiers on inactivated transaction cards and leave the tampered transaction cards behind. As a result of the tampering, upon consumer selection of the transaction card and associated POS activation, an unintended record or account is activated and tied to use of the transaction card, which, in turn, allows the third party to wrongfully access the value associated with the transaction card. In another example, third parties photograph and duplicate account identifiers on inactivated cards, and then monitor the account identifiers to determine when the transaction card with the original account identifier is activated. Once the original account identifier is activated, the third party uses the duplicated account identifier to access at least a part of the value balance in the associated account before the rightful party can access the value balance. Other fraudulent third-party interaction and/or tampering with account identifiers also occurs and/or continues to be developed that allow the fraudsters wrongful access to values owed by the consumer and/or associated retail, restaurant, or similar venues. As such, solutions thwarting or at least diminishing the availability of inactivated account identifiers for tampering while still allowing the transaction cards to be display for selection and activation are desired.

### SUMMARY

A transaction card product comprising a transaction card, an account identifier, a security panel, and an activation code. The account identifier uniquely links the transaction card to a remote account having a balance value available for redemption toward one or more of goods or services. The security panel is coupled to the transaction card and substantially entirely covers the account identifier. The security panel is configured to be at least partially removed from a remainder of the transaction card product to permit access to the account identifier. The activation code has data therein to prompt a point-of-sale terminal to begin a transaction card activation process, the activation code having a first portion directly secured to and extending over the security panel, wherein the activation code is characterized by an absence of any data identifying the remote account.

A multiple-stage method of activating a transaction card linked to a remote account having a balance value available for redemption toward one or more of goods and services where the transaction card is part of a transaction card product includes using a point-of-sale terminal to read an activation code from the transaction card product to automatically prompt the point-of-sale terminal to initiate a card activation process. The activation code is characterized by an absence of any data identifying the remote account. The method further includes at least partially removing a security panel from the transaction card product to substantially simultaneously destroy readability of the activation code and to reveal an account identifier previously hidden from view by the security panel, and using the point-of-sale terminal to read the account identifier from the transaction card product and activating the remote account identified by the account identifier to allow the balance value to be redeemed toward one or more of goods and services, wherein the account identifier identifies the remote account stored in a database and linked to the transaction card. Other transaction card products, assemblies, and associated methods are also described herein.

### BRIEF DESCRIPTION OF THE DRAWINGS

Embodiments of the invention will be described with respect to the figures, in which like reference numerals denote like elements, and in which:

FIG. 1 is a front view illustration of a transaction card with a first account identifier, according to one embodiment of the present invention.

FIG. 2 is a front view illustration of a portion of a transaction product including the transaction card of FIG. 1 and a security panel coupled thereto, according to one embodiment of the present invention.

FIG. 3 is a front view illustration of a transaction card product including the transaction card and the security panel of FIG. 2 with an activation code, according to one embodiment of the present invention.

FIG. 4 is a front view illustration of the transaction card product of FIG. 3 with the removable panel partially removed from the transaction card, according to one embodiment of the present invention.

FIG. 5 is a front view illustration of the transaction card product of FIG. 4 with the removable panel removed, according to one embodiment of the present invention.

FIG. 6 is a rear perspective view of the removable panel following removal from the transaction card, according to one embodiment of the present invention.

FIG. 7 is a front perspective view of a transaction card product

FIG. 8 is a rear perspective view of the transaction card product

FIG. 9 is a rear perspective view

FIG. 10 is a front view illustration of a transaction card product including a transaction card and an associated, unfolded card package, according to one embodiment of the present invention.

FIG. 11 is a rear view illustration of the transaction card product of FIG. 10, according to one embodiment of the present invention.

FIG. 12 is a front view illustration of the transaction card product of FIG. 10 with the package partially folded, according to one embodiment of the present invention.

FIG. 13 is a front view illustration of the transaction card product of FIG. 10 with the package folded, according to one embodiment of the present invention.

FIG. 14 is a right side view of the transaction card product and package of FIG. 13, according to one embodiment of the present invention.

FIG. 15 is a front view illustration of the transaction card product of FIG. 13 during a first stage of activation, according to one embodiment of the present invention.

FIG. 16 is a front view illustration of the transaction card product of FIG. 13 during a second stage of activation, according to one embodiment of the present invention.

FIG. 17 is a front view illustration of a transaction card product, according to one embodiment of the present invention.

FIG. 18 is a flow chart illustrating a method of activation and redemption of a transaction card product, according to one embodiment of the present invention.

FIG. 19 is a schematic illustration of a transaction card product system, according to one embodiment of the present invention.

FIG. 20 is a front view illustration of a transaction card product, according to one embodiment of the present invention.

FIG. 21 is a front view illustration of the transaction card product of FIG. 19 in a first stage of activation, according to one embodiment of the present invention.

FIG. 22 is a front view illustration of the transaction card product of FIG. 19 in a second stage of activation, according to one embodiment of the present invention.

FIG. 23 is a rear view illustration of a transaction card product, according to one embodiment of the present invention.

FIG. 24 is a rear view illustration of the transaction card product of FIG. 23 with a security panel partially peeled upwardly therefrom, according to one embodiment of the present invention.

FIG. 25 is a rear view illustration of a transaction card product of FIG. 23 with a transaction card and the security panel fully separated from each other after peeling the security panel from the transaction card, according to one embodiment of the present invention.

FIG. 26 is a schematic view illustration of data included in an account identifier, according to one embodiment of the present invention.

FIG. 27 is a schematic view illustration of data included in an activation code, according to one embodiment of the present invention.

FIG. 28 is a front perspective view illustration of a transaction card product, according to one embodiment of the present invention.

FIG. 29 is a rear view illustration of the transaction card product of FIG. 28, according to one embodiment of the present invention.

FIG. 30 is a rear view illustration of the transaction card product of FIG. 28 with a security panel partially peeled upwardly therefrom, according to one embodiment of the present invention.

FIG. 31 is a rear view illustration of a transaction card product of FIG. 28 with the security panel fully separated from a remainder of the transaction product after peeling the security panel from the remainder of the transaction product, according to one embodiment of the present invention.

### DETAILED DESCRIPTION

The following detailed description of the invention provides example embodiments and is not intended to limit the invention or the application and uses of the invention. Furthermore, there is no intention to be bound by any theory presented in the preceding background of the invention or the following detailed description of the invention. Relational terms herein such a first, second, top, bottom, etc. may be used herein solely to distinguish one entity or action from another without necessarily requiring or implying an actual such relationship or order. In addition, as used herein, the terms “about” and “substantially” apply to all numeric values or descriptive terms, respectively, and generally indicate a range of numbers or characteristics that one of skill in the art would consider equivalent to the recited values or terms, that is, having the same function or results.

This innovation provides a transaction card product presented with a hidden card account identifier to prevent undesired, third-party tampering with inactivated transaction cards. In one example, the transaction card identifier is securely hidden via a panel, such as a sticker or package portion, and an activation code is printed over the security panel. Removal of the security panel simultaneously destroys the activation code. In this manner, if some third-party tampers with the security panel, the security panel and/or at least the readability of activation code thereon is destroyed. In one example, activation of the transaction card is completed in multiple-stages, such as two-stages, using the activation code and another related code. Transaction card activation cannot be performed if the activation code is destroyed, thereby, allowing identification of the tampered transaction card at the point-of-sale (POS) and generally preventing activation of any transaction card that has been tampered with or otherwise compromised.

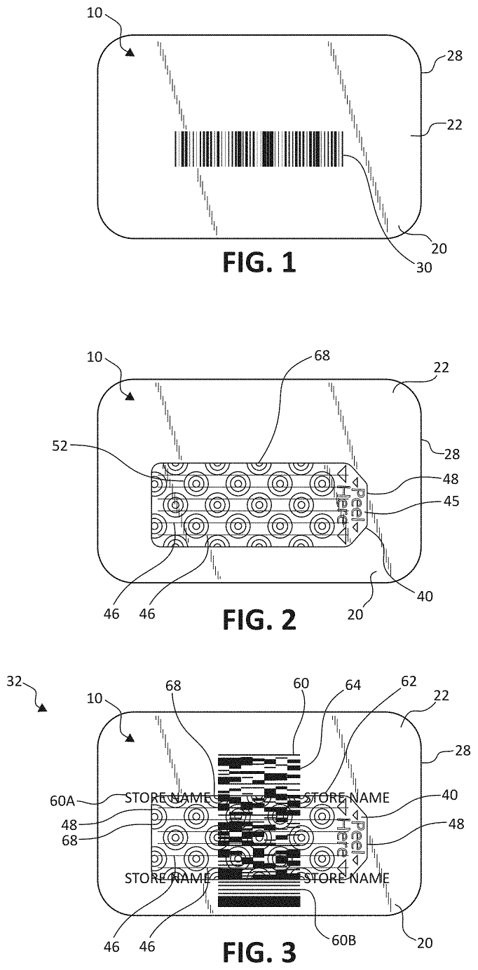

Turning to the Figures, FIG. 1 illustrates one example of a transaction card 10 according to one embodiment of the present invention. In one embodiment, transaction card 10 is formed of a substrate 20. Substrate 20 is any suitable material such as a somewhat rigid, yet flexible, material similar to that commonly used for identification cards, credit cards, etc. More specifically, in one embodiment, substrate 20 is a substantially planar member formed of paper, cardstock, plastic (e.g., polycarbonate, polystyrene, polyvinyl chloride (PVC), acrylonitrile butadiene styrene (ABS), polyethylene terephthalate (PET), teslin, polyactide (PLA) and acrylic), a composite thereof, or other suitable material. In one embodiment, substrate 20 is formed of injection molded plastic or cut from sheet-stock plastic material. Substrate 20 can be formed in any other suitable planar or non-planar configuration as will be apparent to those of skill in the art upon reading this application. In one embodiment, substrate 20 is formed as a substantially planar member having a readily perceivable thickness and defining a first or front surface (not shown) and a second or rear surface 22 opposite the front surface. In one example, each of front surface and rear surface 22 is substantially planar and extends to a perimeter edge 28 of transaction card 10.

As illustrated in FIG. 1, in one embodiment, transaction card 10 includes an account identifier 30 secured thereto, for example, embedded in substrate 20 or printed on or otherwise securely applied to at least one of first surface (not shown) and second surface 22 such as at least one of front surface and rear surface 22. Account identifier 30 includes one or more of a one-dimensional bar code, a two-dimensional bar code, a QR code, a magnetic strip, a smart chip or other electronic device, a radio frequency identification (RFID) device, or another suitable identifier readily machine readable by a POS terminal. In one embodiment, where account identifier 30 is machine readable, account identifier 30 is also readable by a bearer of transaction card 10 such that transaction card 10 can be used when a machine configured to read transaction card 10 is not present (e.g., when using transaction card 10 to make a purchase on a website). For example, account identifier 30 may include a number or letter string or a personal identification number (PIN) identifying the associated account or record and/or a password (not illustrated) associated therewith. In one embodiment, account identifier 30 is printed on or otherwise applied or fixedly connected to rear surface 22 of substrate 20.

Account identifier 30 links transaction card 10 to a financial or other stored-value account or record, for example, by identifying an account or record of value. The account or record indicates a value balance (e.g., monetary value, points, time value, or other balance) associated with transaction card 10. In one embodiment, the account or record is maintained on a database, other electronic or manual record-keeping system, or, in the case of “smart cards” for example, on a chip or other electronic device on/in transaction card 10 itself. Accordingly, by scanning account identifier 30, the account or record linked to transaction card 10 is identified and can subsequently be activated, have amounts debited therefrom and/or have amounts credited thereto. In this manner, account identifier 30 is useful for activation and/or redemption, according to embodiments of the present invention. Account identifier 30 is one example of on-card means for linking transaction card 10 with an account or record. In one example, each account identifier 30 is unique to a single transaction card or a group of transaction cards linked to the same account or record of value.

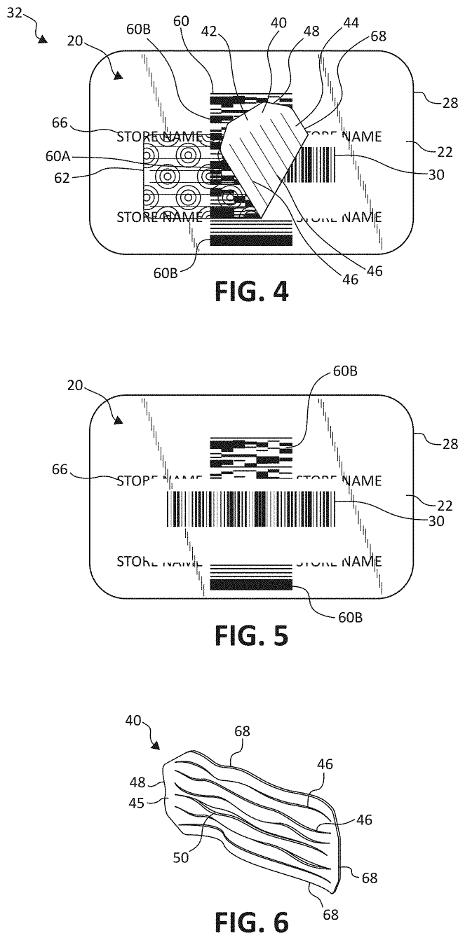

Since an exposed account identifier 30 has historically been proven to be susceptible to tampering, in one embodiment of the invention, a security panel 40 is applied over account identifier 30 such that transaction card 10 and security panel 40 collectively define a transaction card product 32. Security panel 40 not only hides account identifier 30 from view, but, in one embodiment, also is configured to provide indication of any tampering with security panel 40. As illustrated in FIGS. 2-6, in one example, an adhesive layer 42 is applied over rear surface, generally indicated at 44 through adhesive layer 42, of security panel 40 collectively forming an adhesive label. In this manner, security panel 40 is detachably adhered to transaction card 10, such that security panel 40 is adhered directly to rear surface 22 over account identifier 30 (see FIG. 1 as compared to FIG. 2) of transaction card 10. In this embodiment, adhesive layer 42 is formed of an adhesive that securely holds rear surface 22 of transaction card 10 (FIG. 4) when applied thereto, but still allows removal from transaction card 10 when desired.

Security panel 40, in one example, includes one or more slits 46, such as a plurality of slits 46, extending entirely through at least security panel 40, and in one embodiment, through security panel 40 and adhesive layer 42 Slits 46 may be formed in any number of suitable arrangements, but, in one example, does not extend to a perimeter 44 of security panel 40, or at least do not extend through one side edge 48 of security panel 40 forming an undisturbed flange 45 of security panel 40 adjacent side edge 48 and configured to facilitate removal of security panel 40 from transaction card 10. In other embodiments slits 46 extend to perimeter of security panel 40 to further separate security panel 40 upon removal from transaction card 10 as will be further described below. In one embodiment, adhesive layer 42 does not extend entirely to side edge 48 such that flange 45 is easier to grasp when removing security panel 40 from transaction card 10.

Slits 46 are positioned and configured such that, upon pulling security panel 40 away from transaction card 10, security panel 40 pulls apart from itself along slits 46 leaving gaps 50 as shown in FIG. 6 depicting security panel 40 upon removal from transaction card 10. Although shown as a series separate vertical lines, slits 46 may be formed in any suitable configuration that enhances destruction of security panel 40 upon removal from transaction card 10, while preferably, but not necessarily, allowing for removal of security panel 40 from transaction card 10 in generally a single pull. In one embodiment, security panel 40 is formed of a paper, plastic, vinyl, or other suitable material configured to roll upon itself upon removal from transaction card 10 in a manner even further enhancing gaps 50. Slits 46, gaps 50 and the configuration of security panel 40 make it generally impossible and impractical to reapply security panel 40 to transaction card 10 in any manner appearing to be smooth and undisturbed, that is, visually matching the initial application of security panel 40 to transaction card 10. In this manner, security panel 40 is configured to deter fraud as will be further described below. In one embodiment, indicia 52 is printed to security panel 40 to further enhance the security features thereof as indicated in FIG. 2. More specifically, in one example, indicia 52 is generally at least partially continuous over slits 46 such that aligning portions of indicia 52 over slits 46 would be an added complication to any attempt to reapply security panel 40 to transaction card 10 following tampering or other initial removal of security panel 40 from transaction card 10.

Once security panel 40 is applied to transaction card 10 over account identifier 30 as shown in FIG. 2, for example, an activation code 60 is applied both security panel 40 and transaction card 10. Activation code 60 includes one or more of a one-dimensional bar code, a two-dimensional bar code, a QR code, a magnetic strip, a smart chip or other electronic device, a radio frequency identification (RFID) device, or another suitable identifier readily machine readable by a POS terminal. In one embodiment, where activation code 60 is machine readable, activation code 60 is also readable by a bearer of transaction card 10 such that transaction card 10 can be used when a machine configured to read transaction card 10 is not present (e.g., when using transaction card 10 to make a purchase on a website). For example, activation code 60 may include a number or letter string or a personal identification number (PIN) identifying the associated account or record and/or a password (not illustrated) associated therewith. In one embodiment, activation code 60 is printed on or otherwise applied or fixedly connected to rear surface 22 of substrate 20 and security panel 40. In this configuration and due at least partially to slits 46, once security panel 40 is removed from transaction card 10, it is extremely difficult to reapply security panel 40 in a manner that would render activation code 60 readable.

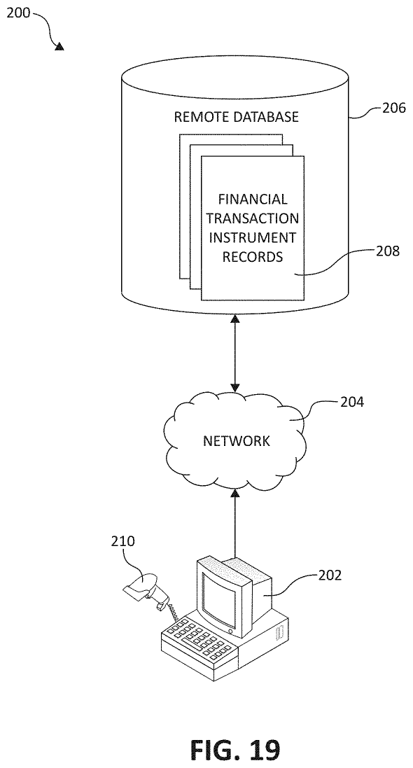

In one example, activation code 60 includes a machine-readable instruction prompting a point-of-sale terminal 202 (FIG. 19) to begin the process of activating a corresponding transaction card 10 to allow for future redemption of a value balance associated with transaction card 10. In one embodiment, activation code 60 is characterized by an absence of any machine-readable or other information that is capable of identifying the account or record of value balance associated with the particular transaction card 10. In this manner, activation code 60 may not be unique to a single transaction card product 32, but instead may be used for a large number of transaction card products 32.

For example, as illustrated in FIG. 3, activation code 60 is printed to include at least one first code portion 60A extending over security panel 40 and at least one second code portion 60B, for instance, two second portions as illustrated, applied to transaction card 10 outside the boundaries of security panel 40. Each code portion 60A and 60B of activation code 60 alone is insufficient to provide all the data of activation code 60 required to complete activation of transaction card 10, as will be further described in the method below. When printed over security panel 40, upon at least removal of security panel 40 from or partially pulling security panel 40 away from transaction card 10, first code portion 60A of security panel 40 is also removed from its initial place of securement to transaction card 10, thereby, destroying usability of activation code 60 as indicated in FIG. 4.

In one embodiment, in addition to printing activation code 60 over security panel 40 and rear surface 22 of transaction card 10, additional security indicia 66 are also printed or otherwise applied to extend at least partially over each of security panel 40 and rear surface 22 of transaction card 10 to provide additional visual cues indicating tampering with transaction card product 32. As illustrated, for example, security indicia 66 include text printed directly over a perimeter edge 68 of security panel 40, such that upon removal of security panel 40 from transaction card 10, the text of security indicia 66 is partially removed as well, for instance, a bottom or top half of the text, provide a visual indication that security panel 40 has been removed, as most clearly illustrated in FIGS. 4 and 5.

As described above, transaction card product 32 provides two machine-readable codes, that is account identifier 30 and activation code 60, used in activating transaction card 10 in a multiple-stage process that will be further described below. In general, during use, activation code 60 is scanned or otherwise entered into POS terminal, in a first stage of activation, prompting the POS terminal to begin a sequence for activating a transaction card. The second code, in this case, account identifier 30 on transaction card 10, cannot be accessed without removing security panel 40, the removal of which simultaneously destroys activation code 60. Account identifier 30 is needed in the second stage of the activation process to identify the account or record associated with the transaction card 10 and to allow that account or record to be activated for use. In this manner, transaction card product 32 provides security by hiding account identifier 30 or any other indication of the account or record associated with transaction card 10 while transaction card product 32 is on display and/or generally accessible to the public including potential fraudsters. Transaction card product 32, more specifically, security panel 40 and the application of security panel 40 to transaction card 10 is specifically configured such that any wrongful attempt to access account identifier 30 will destroy the activation code 60 in a manner designed largely to prevent activation of transaction card 10, namely the associated record or account. In particular, an associate controlling the POS terminal is met with a hard stop to the activation process when activation code 60 is either missing or is otherwise unreadable such that the activation process cannot be initiated based on use of transaction card product 32 itself, as will be further described in the method below.

Other embodiments of forming a transaction card product including transaction card 10 in a manner deterring third-party fraudulent interaction with account identifier 30 or other identifier associated with the account are also contemplated.

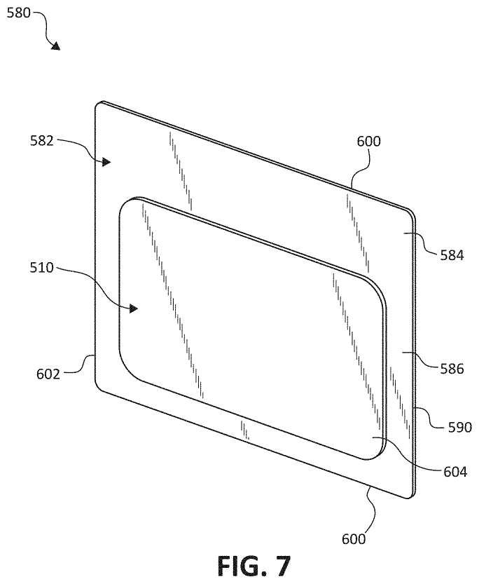

For example, FIGS. 7-9 illustrate a transaction card product 580 including transaction card 510, wherein like numeral references denote like features of transaction card product 580 as compared to transaction card product 32 described above. Transaction card product 580 includes transaction card 510 mounted on a backer, carrier, or other card package 582. In one embodiment, card package 582 is generally formed from a planar member 584 formed from paperboard, plastic, or other suitable material and defines a first or front surface 586, a second or rear surface 588 opposite front surface 586, and a perimeter formed by opposing longitudinal edges 600 and transversely extending first end edge 602 and second end edge 604. In one embodiment, card package 582 additionally defines a window 606 through planar member 584 as will be further describe below. Otherwise shaped card packages and/or card packages having various panels and/or folds are also contemplated as will be apparent to those of skill in the art upon reading this application.

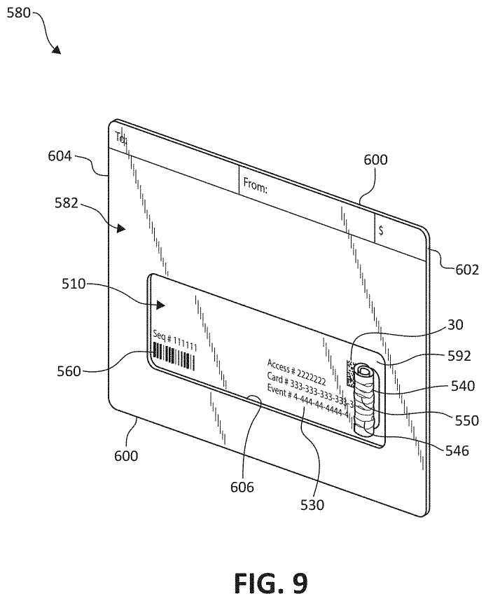

Like transaction card 10, transaction card 510 includes account identifier 30 and an activation code 560 secured thereto, for example, embedded in substrate 20 or printed on or otherwise securely applied to at least one of a first surface 590 and second surface 592. Activation code 560 is substantially identical to activation code 60 described above, but, in one embodiment, is printed directly to one of first surface 590 and second surface 592 of transaction card 510, rather than over a security panel 540 (described below). In one example, additional card or card type and/or account information is printed on transaction card 510 as generally indicated at 530 in FIG. 9. As illustrated, in one example, transaction card 10 is placed on transaction card package 582 such that both account identifier 30 and activation code 560 are positioned within and viewable through window 606 of card package 582.

Transaction card product 580 additionally includes a security panel 540, which is substantially identical to security panel 40 other than differences specifically described herein. For example, security panel 540 includes one or more slits 546 extending substantially through an entire thickness of security panel 540. Security panel 540 is adhered to transaction card 510 in a selectively secure manner. Security panel 540 is securely adhered to transaction card 510 such that upon peeling security panel 540 from transaction card 510 to remove security panel 540, security panel 540 is separated from itself along each of the one or more slits 546 along a number of linear or non-linear segments of each of one or more slits 546 rendering security panel 540 greatly deformed from its original shape and making it very difficult to reuse security panel 540 in a similar manner or without readily visible and identifiable deformity and visible gaps 550. Like security panel 40, security panel 40 is formed with slits 546 and adhesive to generally allow security panel 40 to be removed from transaction card 510 and separated along slits 546 in a single pull away from transaction card 510.

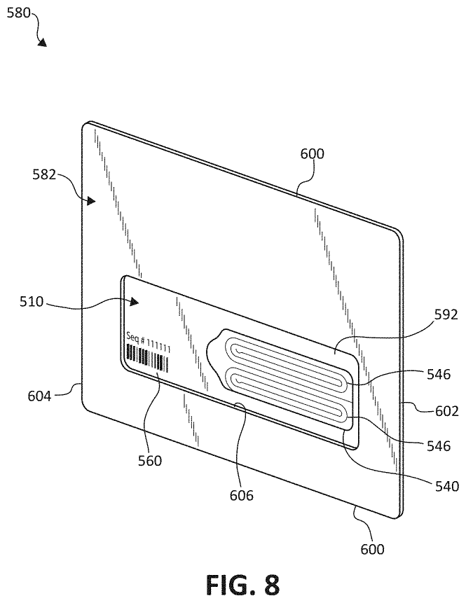

Security panel 540 is positioned, on the one of first surface 590 and second surface 592 that has account identifier applied thereto, to cover account identifier 30 and is adhesively secured to the one of first surface 590 and second surface 592. For example, as illustrated in FIGS. 8 and 9, account identifier 30 is printed to second surface 592, and security panel 540 is adhered to second surface 592 to completely or at least partially cover account identifier as shown in FIG. 8. As illustrated in FIGS. 8 and 9, in one example, activation code 560 is printed to transaction card 510 away from account identifier 30 such that while security panel 540 covers account identifier 300 it does not cover, or at least does not fully cover, activation code 560.

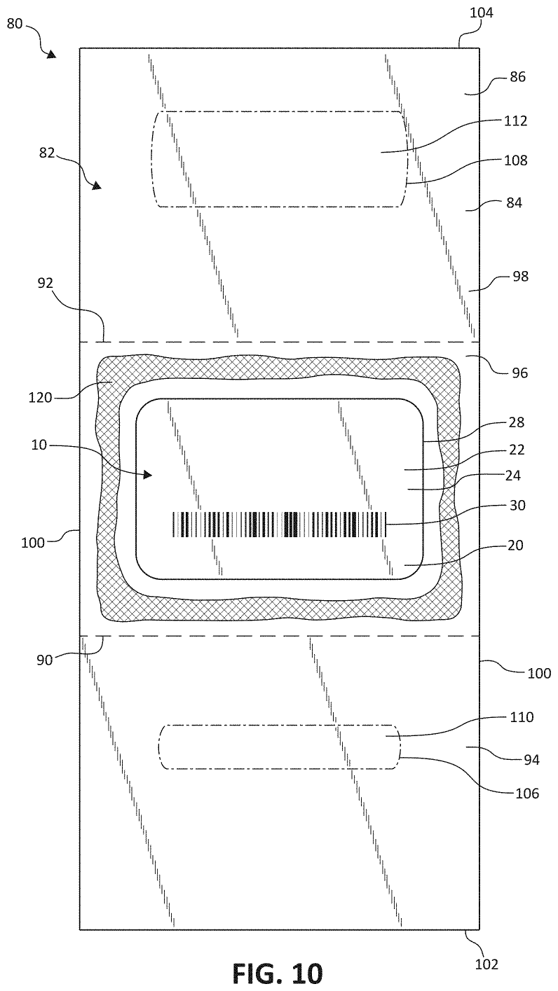

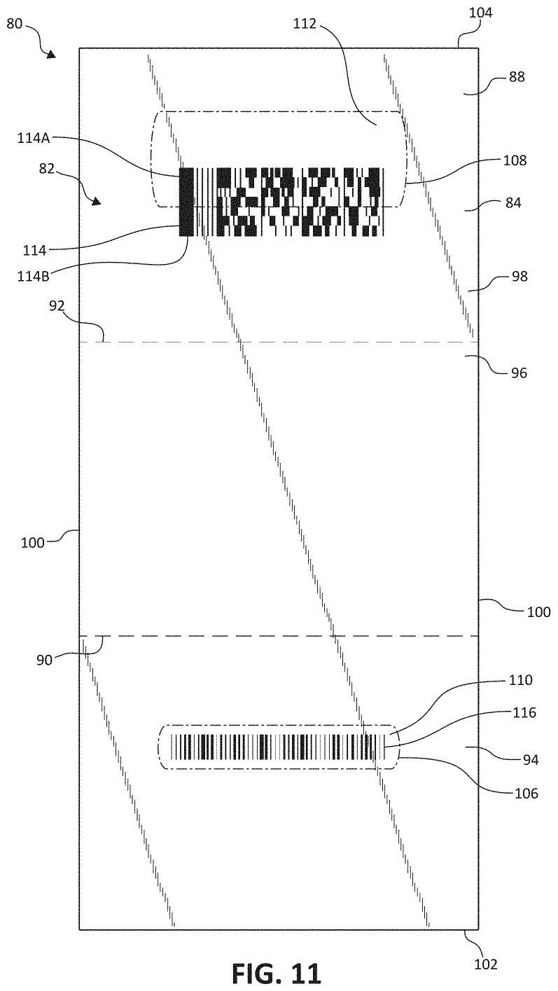

In another example, as illustrated in FIGS. 10-16, a transaction card product 80 includes transaction card 10, wherein like numeral references denote like features of transaction card product 80 as compared to transaction card product 32 described above. Transaction card product 80 includes transaction card 10 mounted on a backer or carrier generally referred to herein as card package 82. Referring to the front and back illustrations of FIGS. 10 and 11 showing transaction card product 80 with card package 82 in an unfolded position, card package 82 is generally formed from a planar member 84 formed from paperboard, plastic, or other suitable material and defines a first or interior surface 86, a second or exterior surface 88 opposite interior surface 86, and a perimeter formed by opposing longitudinal edges 100 and transversely extending first end edge 102 and second end edge 104.

Card package 82 is divided into panels or sections via fold lines, for example, via a first fold line 90 and a second fold line 92 transversely extending from one of longitudinal edges 100 to the other and each spaced from each other and each of end edges 102 and 104. A first section 94 of card package 82 is defined between first end edge 102 and first fold line 90, an intermediate or second section 96 of card package 82 is defined between first fold line 90 and second fold line 92, and third section 98 of card package 82 is defined between second fold line 92 and second end edge 104. First section 94 includes a substantially closed perforation 106 extending through both interior and exterior surfaces 86 and 88 defining a removable tab 110 therein. In one example, perforation 106 and removable tab 110 are both positioned in an interior of first section 94 spaced from opposing longitudinal edges 100, first end edge 102, and first fold line 90. In one embodiment, perforation 106 and removable tab 110 are not included on card package 82.

Referring to FIG. 11, a second or package account identifier 116 is printed or otherwise coupled to exterior surface 88 of first section 94 of card package 82, for example, on removable tab 110 when present. Like account identifier 30 on transaction card 10, package account identifier 116 includes one or more of a one-dimensional bar code, a two-dimensional bar code, a QR code, a magnetic strip, a smart chip or other electronic device, a radio frequency identification (RFID) device, or another suitable identifier readily machine readable by a POS terminal. In one embodiment, where package account identifier 116 is machine readable, package account identifier 116 is also readable by a bearer of transaction card product 80, such as the consumer or POS terminal operator, such that transaction card product 80 can be used when a machine configured to read package account identifier 116 is not present.

Like account identifier 30, package account identifier 116 is unique to the account or record linked to transaction card 10. However, in one example, package account identifier 116 differs from account identifier 30 and is generally usable only for activation and cannot be used for redemption of the value balance. This provides an additional layer of security as compared to transaction card product 32 as the actual on-card account identifier 30 is not used or even revealed during activation. In one embodiment, care is taken in assigning package account identifier 116 using encryption, random assignment, or other suitable methods such that a fraudster is not readily able to determine redemption, on-card account identifier 30 from only seeing package account identifier 116. Accordingly, by scanning account identifier 30, the account or record linked to transaction card 10 is identified and can subsequently be activated, have amounts debited therefrom, and/or have amounts credited thereto. In this manner, account identifier 30 is useful for activation and/or redemption, according to embodiments of the present invention. Account identifier 30 is one example of on-card means for linking transaction card 10 with an account or record.

Third section 98 includes a substantially closed perforation 108 extending through both interior and exterior surfaces 86 and 88 defining a removable tab 112 therein, according to one embodiment of the invention. In one example, perforation 108 and removable tab 112 are both positioned in an interior of third section 98 spaced from opposing longitudinal edges 100, second fold line 92, and second end edge 104. In one embodiment, removable tab 112 is sized larger than removable tab 110, and, as will be further described below, is positioned to fit directly over and cover removable tab 110 upon full assembly of transaction card product 80.

Referring to FIG. 11, card package 82 includes an activation code 114 printed or otherwise coupled to exterior surface 88 of removable tab 112, in one embodiment. Activation code 114 is similar to activation code 60 (FIGS. 3 and 4) and includes one or more of a one-dimensional bar code, a two-dimensional bar code, a QR code, a magnetic strip, a smart chip or other electronic device, a radio frequency identification (RFID) device, or another suitable identifier readily machine readable by a POS terminal. In one embodiment, where activation code 114 is machine readable, activation code 114 is also readable by a bearer of transaction card 10 such that transaction card 10 can be used when a machine configured to read transaction card 10 is not present. Also, like activation code 60, in one example, activation code 114 includes a machine-readable prompt instructing POS terminal 202 (FIG. 19) to begin the process of activating a corresponding transaction card 10 to allow for future redemption of the value balance associated with transaction card 10. In one embodiment, activation code 114 is characterized by an absence of any machine-readable or other information that is capable of identifying the account or record of value balance associated with the particular transaction card 10. In this manner, activation code 114 may not be unique to a single transaction card product 32, but instead may be used for a large number of transaction card products 30.

In one embodiment, activation code 114 is printed on or otherwise applied or fixedly connected to exterior surface 86 in a manner extending over perforation 108 such that activation code 114 is partially included on removable tab 112 and partially included on a remainder of third section 98. More specifically, activation code 114 includes a first activation code portion 114A on removable tab 112 and at least one second activation code portion 114A on a remainder of third section 98. With this configuration, removal of removable tab 112 cuts activation code 114 in two or more parts, removing activation code portion(s) 114A from transaction card product 80.

Each code portion 114A and 114B of activation code 114 alone is insufficient to provide all the data of activation code 114 required to prompt POS terminal 202 (FIG. 19) to begin the transaction card activation process, as will be further described in the method below. Accordingly, since activation code 114 is printed over removable tab 112, upon at least partial removal of removable tab 112 from or partially pulling removable tab 112 away from transaction card 10, first activation code portion 114A of third section 98 is also removed from its initial place of securement to a remainder of third section 98, which, in turn, destroys usability of activation code 60 as indicated in FIG. 4. In other words, removal of activation code portion 114A renders activation code 114B unreadable or otherwise informationally insufficient to provide a POS terminal 202 with a prompt the begin the transaction card activation process. In one example, third section 98 or, more specifically, removable tab 112, is also considered a security panel having a similar purpose as security panel 40 (see FIGS. 2-4).

Once card package 82 is formed and printed with or otherwise coupled with package account identifier 116 and activation code 114, assembly of transaction card product 80 continues by securing transaction card 10 to an interior of second section 96 of card package 82. For example, transaction card 10 is secured to card package 82 in a position substantially centered on second section 96 between opposing longitudinal edges 100 and/or first fold line 90 and second fold line 92. In one example, transaction card 10 is positioned such that account identifier 30 faces away from second section 96, however, other configurations are also contemplated.

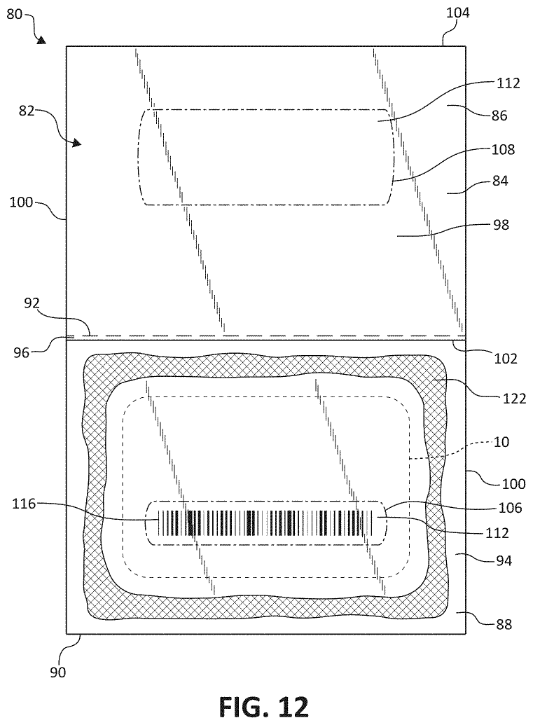

Once transaction card 10 is secured to card package 82, first section 94 is folded about first fold line 90 to cover at least a portion of, if not a substantial entirety of, second section 96 of card package 82 and transaction card 10. In one example, second section 96 is adhered to first section 94 via a substantially permanent or other strong adhesive 120 (FIG. 10), for example, extending substantially entirely around transaction card 10, such that transaction card 10 is securely enclosed by card package 82. Collectively referring to FIGS. 10 and 11 and the partially assembled view of FIG. 12, when so assembled, perforation 106 is positioned such that removable tab 112 therein is positioned directly over account identifier 30 on transaction card 10, as will be further described below and illustrated in FIG. 16.

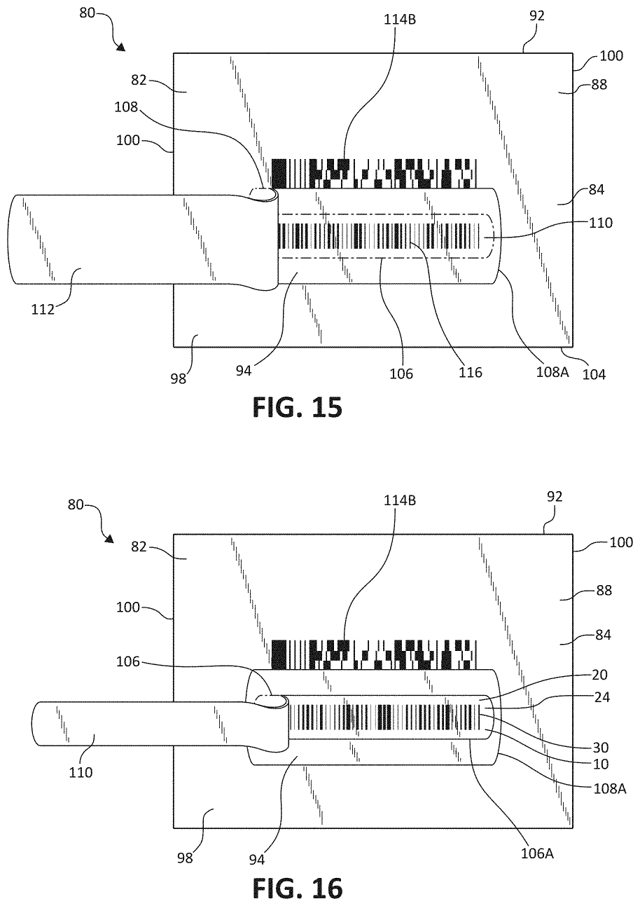

In one embodiment, third section 98 of card package 82 is folded about second fold line 92 to cover first section 94 of card package 82, transaction card 10, and second section 96 of card package 82. For example, interior surface 86 of third section 98 of card package 82 is secured to exterior surface 88 of first section 94 of card package 82 via a substantially permanent adhesive 122 or another suitable adhesive. When third section 98 is folded into place, removable tab 112 of third section 98 extends directly over package account identifier 116. Removal of removable tab 112 reveals package account identifier 116 through a hole 108A (see FIG. 15) left in third section 98 of card package 82 upon removal of removable tab 112.

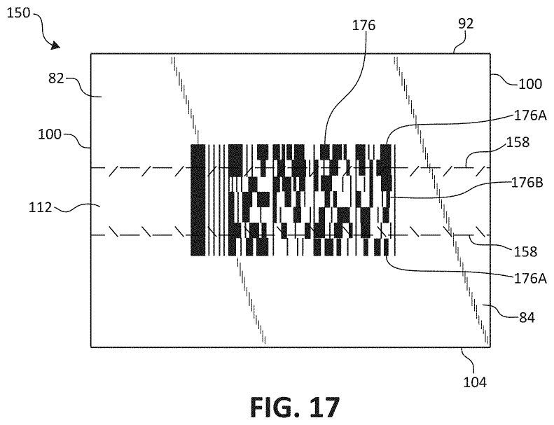

FIG. 17 illustrates a transaction card product 150 similar to transaction card product 80 that includes two perforated lines 158 each extending between opposing sides edges 100 of card package 82 to define a security panel in the form of a removable tab 112 therebetween instead of a closed shape perforation 108 and removable tab 112 of transaction product 80. Like activation code 114 is formed over perforation 108, for transaction card product 150, activation code 176, which is similar to activation code 114, except where specifically described herein, is formed across one or both perforations such that first portion 176A is formed on security panel

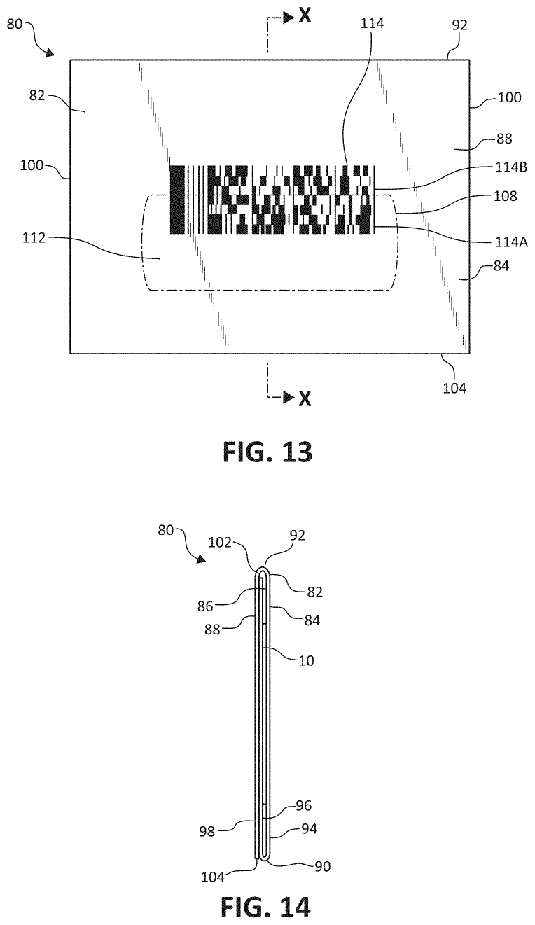

Additionally, referring to FIGS. 13 and 14, upon full assembly of transaction card product 80, activation code 114 is visible while package account identifier 116 and account identifier 30 are enclosed within card package 82. Since activation code 114 only includes machine readable information or instruction generally prompting POS terminal 202 (FIG. 19) to begin the process to activate a transaction card and does not include information identifying any particular account or record having a value balance, there is very little, if any, risk of fraudsters using only the exposed activation code 114 to tamper with transaction card 10 or processing thereof. As will be further described below, in accessing package account identifier 116 and/or account identifier 30, card package 82 is at least partially destroyed including destruction of activation code 114 in a manner that will greatly deter activation of any transaction card that has been subjected to tampering and/or is associated with an account or record that has been subjected to tampering. Other variations on transaction card product 80 are also contemplated that still provide for added security keeping any account or record information initially covered or otherwise hidden from view. For example, perforation 106 and removable tab 110 may be eliminated, first section 94 and package account identifier 116 may be eliminated, etc.

FIGS. 13-16 show transaction card product 80 in the various stages of activation, for example, in the activation process 180 generally illustrated by the flow chart of FIG. 19. Transaction card product 80 is fully assembled and intact during retail display in a manner similar to that shown in FIG. 13, in one example. At 182, a fully assembled and intact transaction card product 80 is selected by a consumer and presented at the POS terminal 202 (FIG. 19) for activation. At 184, a consumer or POS terminal 202 operator finds a first code, more specifically, activation code 114, which, in one example, is printed or otherwise secured to an outside of transaction card product 80 such that no part of transaction card product 80 needs to be opened to access activation code 114 and determines whether activation code 114 is intact. Activation code 114 may be determined to be non-intact via visual inspection prior to scanning or otherwise attempting to read activation code 114. For example, activation code 114 may be determined to be non-intact upon reading activation code 114 with scanner 210 of POS terminal 202 or upon trying to enter activation code 114 into POS terminal 202 in a manner that does not results in automatic initiation of the activation process as expected for an intact activation code 114. Similarly, activation code 114 may be determined to be intact when scanning or otherwise entering activation code 114 into POS terminal 202 automatically causes POS terminal 202 to begin the transaction card activation process, that is executing activation instructional code. More specifically, in one embodiment, both portions 114A and 114B of activation code 114 must be present and properly secured to one another to allow POS terminal 202 to read activation code 114 without need for any manual entry of activation code 114 information. If either portion 114A or 114B of activation code 114 is missing, activation code 114 is not intact and scanning activation code 114 to POS terminal 202 will result in no valid action or prompt to execute coded instructions beginning the activation process.

If activation code 114 is determined to be non-intact, the at 186, the invalidity of the activation code 114 triggers the consumer or operator of POS terminal 202 that transaction card product 32 is deficient and may have been tampered with. In one example, upon discovery of a deficient transaction card product 32, that transaction card product 32 will be destroyed or otherwise accounted for, and the consumer will be asked to select another transaction card product 32 for activation of the transaction card 10 included therein at 186 before starting transaction card product activation process 180 again.

If activation code 114 is determined to be intact at 184, activation code 114 is entered at POS terminal 202, for example, via a scanner 210 or another machine-readable device of POS terminal 202. In one example, operations 188 and 184 are completed substantially simultaneously such as where activation code 114 is determined to be intact via scanning and automatic execution of an activation instructional code sequence.

When activation code 114 is entered at 188, POS terminal 202 initiates transaction card activation by executing instruction code, stored locally or at a remote database 206 (FIG. 19), for the activation. In executing the activation instruction code, at 190, POS terminal 202 prompts consumer or POS operator to enter a second code identifying the account or record tied to transaction card 10, such as account identifier 30 on transaction card 10 (FIGS. 1 and 5) or a package account identifier 116 on card package 82 (FIG. 15). In one embodiment, in order for second code to be entered into POS terminal 202, transaction card product 32 or 80 is altered in a manner substantially simultaneously destroying continued access or readability of first code, that is, of activation code 60 or 114, and revealing the second code. For example, referring to FIGS. 1-6, security panel 14 is peeled away from transaction card 10 revealing account identifier 30 and, due to the nature of security panel 40 and the location of activation code 60, as described above, destroying readability of activation code 60. Alternatively, for transaction card product 80, where the security panel is removable tab 112, removable tab 112 is peeled away from a remainder of package 82 as facilitated by perforation 108 leaving hole 108A through third section 98, revealing package account identifier 116, and tearing activation code 114 in at least two portions 114A and 114B to destroy readability of activation code 114. In other embodiments, the activation code is not destroyed in accessing the account identifier, for example, as illustrated in FIGS. 7-9 with activation code 560, account identifier 30, and security panel 540.

At 192, the second code, for example, account identifier 30 on transaction card 10 (FIGS. 1 and 5) or a package account identifier 116 on card package 82 (FIG. 15) is read (e.g., scanned) or otherwise entered into POS terminal 202. Referring to FIG. 19, in one embodiment, POS terminal 202 is in communication with a remote database 206 either directly or via a network 204. Examples of suitable networks 204 include, but are not limited to, a local area network (LAN), a wireless local area network (WLAN), a wide area network (WAN), the Internet, personal area network (PAN), enterprise private network (EPN), virtual private network (VPN), metropolitan area network (MAN), the world wide web, and the like networks and/or combinations thereof.

Remote database 206, in one embodiment, contains various instructional code to run processes on POS terminal 202 such as general item processing or specialty processes, like transaction card activation. In one example, remote database 206 includes financial transaction instrument records 208, which link various account identifiers to specific records or accounts of the value balance associated with each individual transaction card 10 or group of transaction cards 10, if all transaction cards 10 in a group are able to load value to and/or redeem value from the same account or record. In one embodiment, financial transaction instrument records 208 link each account identifier 30 to a corresponding record or account. In one embodiment, the same record links a package account identifier 116 that is part of the same transaction card product 80 with account identifier 30 to that same corresponding record or account. In another embodiment, separate records in financial transaction instrument records 208 link package account identifier 116 to an account or record and link account identifier 30 to the same account or record for added security.

At 194, POS terminal 202 activates the account or record readying the value balance associated with transaction card 10 for redemption toward purchases and/or use of associated services at least in part as informed by access to financial transaction instrument records 208, as described above. In one embodiment, activation of a financial account tied to transaction card 10 includes changing a stored status identifier for the financial account such as where a predefined value balance for the transaction card 10 has already been determined and associated with transaction card 10. In one embodiment, activation of a financial account tied to transaction card 10 includes changing a stored status identifier for the financial account and/or providing a consumer-specified amount to be added to an initial zero value balance for the transaction card 10, where that amount will be the new value balance of the account that is available for use toward the purchase and/or use of goods and/or services. Once activated, transaction card 10 is ready for use as a typical transaction card 10.

In one example, activation is still further verified, by removal of removable tab 110 to create a hole 106A and POS terminal 202 reading account identifier 30 through hole 106A and subsequently cross-checking that account identifier 30 is associated with the same account identified using package account identifier 116, while in other embodiments, this step is eliminated. The consumer is then free to take transaction card 10 for use and may destroy any associated package 82 or security panel 40. Once transaction card 10 is activated, responsibility for maintaining the security of transaction card 10 shifts from the retailer or card provider to the end consumer.

At 196, a consumer is able to redeem transaction card 10 toward purchase of product or services at POS terminal 202 or other terminals having access to the account or records 208 stored in remote database 206. As used throughout this application, POS terminal 202 is intended to be given a broad reading to include retail point-of-sale terminals as well as any kiosk, workstation, home computer, mobile computing device, etc. that is configured to activate and/or redeem transaction cards, etc.

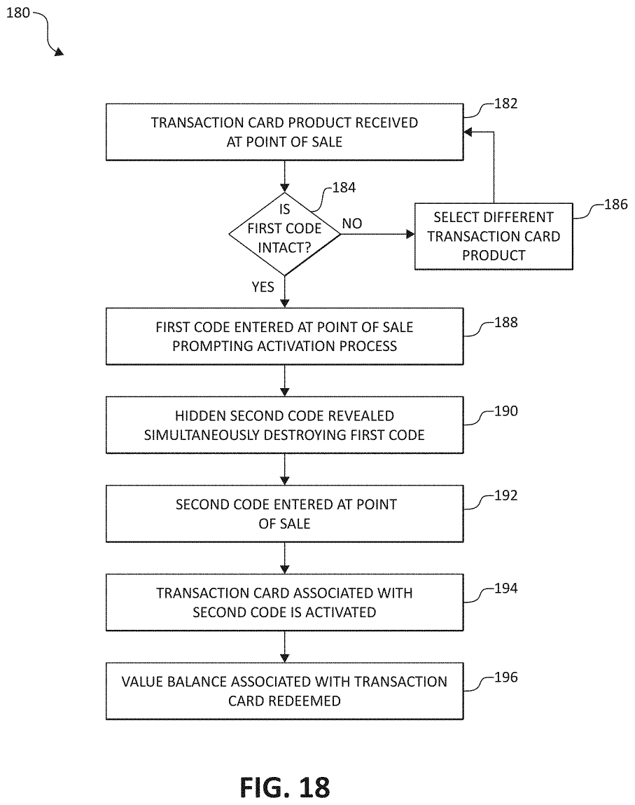

As described for the methods and products above, transaction card products as described herein are configured to provide for added security prior to activation by hiding any account identifier linked to the actual account or record tracking the balance value of a transaction card from view and only providing access to any such account identifier via destruction of associated packaging and, more preferably, via destruction of a machine-readable code to begin the transaction card activation process. Due to this arrangement, associated cards are processed in a two-stage manner (see operations 188 and 192 in FIG. 18) to add security to the transaction cards. More particularly, any fraudster attempting to tamper with an account identifier and/or to photograph, denote, or otherwise view an account identifier for later misuse would have to destroy the activation code to gain access to the account identifier. The destruction of the activation code provides a hard stop to the first stage (see operation 188) of processing a card for activation, as the consumer or other operator of POS terminal will be unable to initiate the transaction card process without an intact activation code. This will generally prevent activation of transaction cards that have been tampered with and/or otherwise wrongfully damaged, thereby thwarting many of the major threats of fraud in using transaction card products.

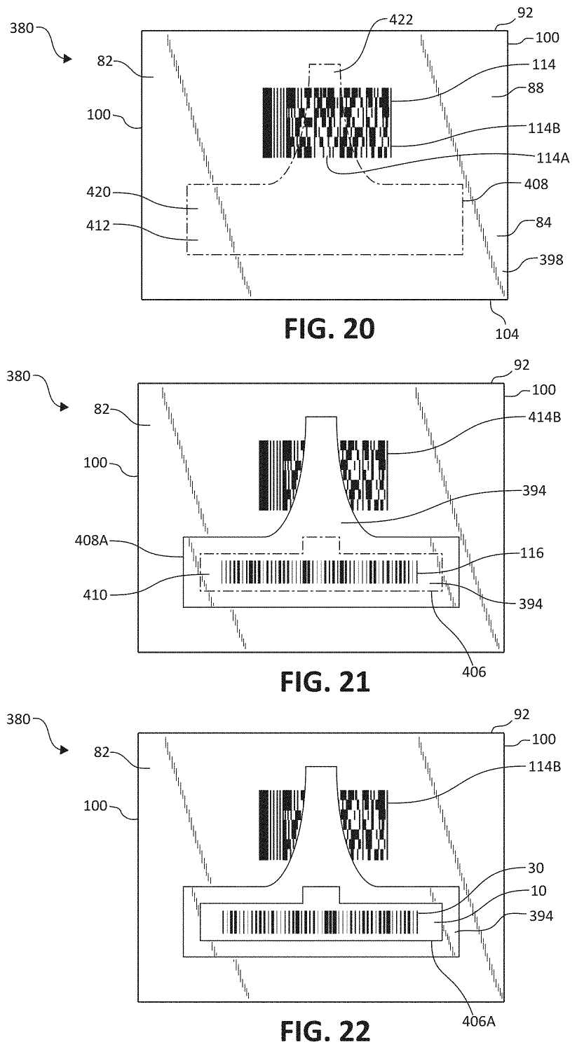

Various other packaging and/or auxiliary panel designs are also contemplated for use in a similar. For example, FIGS. 20-22 illustrate a transaction card product 380 that functions similarly to transaction card product 80, but with a slightly different layout, and has like numerals denoting like features between transaction card products 80 and 380. More particularly, transaction card product 280 includes a first removable tab 410 of first section 394 of transaction card product 380, defined by perforation 406, including package account identifier 116 positioned over account identifier 30 of transaction card 10 enclosed in package 82. Second removable tab 412 is formed in third section 398 of package 82, as defined by perforation 408, and both covers package account identifier 116 and extends way therefrom forming a first portion 420 over package account identifier 116 and a second portion 422 extending away from package account identifier 116. In this manner, FIG. 20 illustrates transaction card product 380 in its initial on-sale or display state prior to initiation of the activation process, FIG. 218 illustrates transaction card product 380 in after stage one to ready transaction card product 380 for stage two of the activation process, and FIG. 22 illustrates an optional state of transaction card product 380 for further verification during the activation process and/or to provide access to account identifier 30 for redemption.

Activation code 114 is printed or otherwise secured to package 82 such that it extends over perforation 408 to be partially included on second portion 422 of second removable tab 412 and partially included on a remainder (i.e., a portion other than second removable tab 412) of third section 398 of package 82. Transaction card product 380 functions and facilitates security via two-stage card activation in a similar manner as described above for transaction card product 80, with the primary difference being the enlarged second removable tab 412 and the positional offset of activation code 114 as compared to package account identifier 116, or, if package account identifier 116 is removed, as compared to account identifier 30 on transaction card 10. In other embodiments, removable tabs 110, 410, 112, and/or 412 may be attached to a remainder of the associated package 82 or 482 via a fold line (not shown) such that the removable tabs 110, 410, 112, and/or 412 are folded away from the underlying account identifier 30 or 116 rather than removed completely from a remainder of the packaging. Other variations of a transaction product in accordance with the present invention are also contemplated and will be apparent to those of skill in the art after reading the present application.

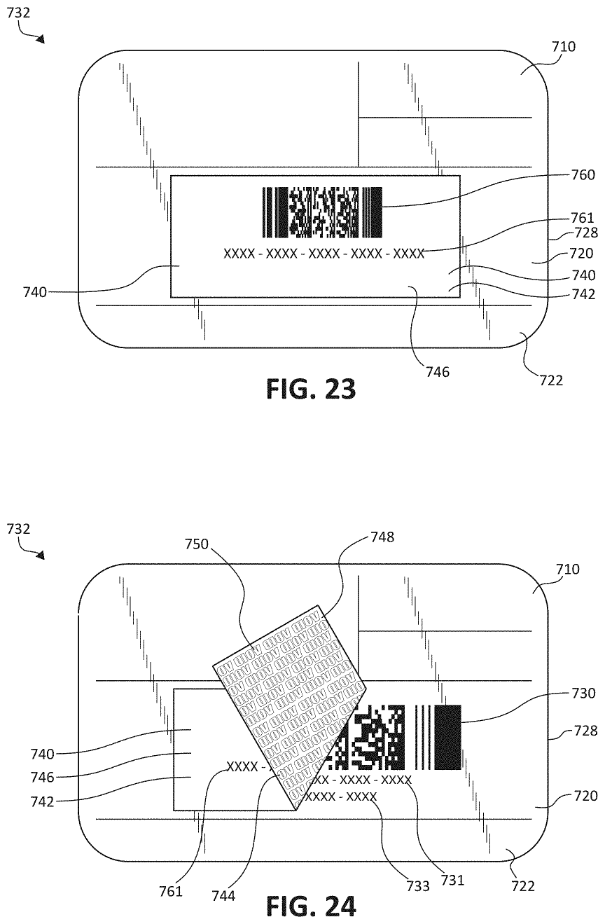

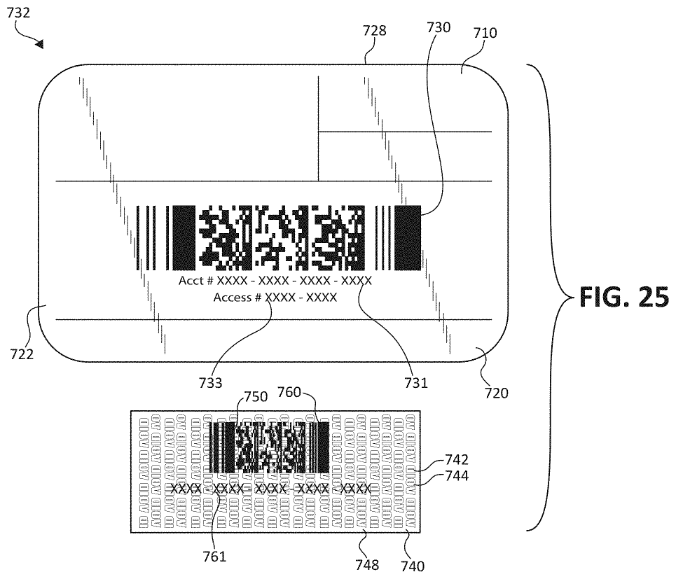

FIGS. 23-25 illustrate a transaction card product 732 including a transaction card 710 similar to transaction card 10, except where specifically differentiated herein, according to one embodiment of the present invention. Referring to FIG. 25, transaction card 710 is formed of a substrate 720 similar to substrate 20 and including a first, substantially planar surface, such as a rear surface 722, and a perimeter edge 728. In one embodiment, transaction card 710 includes an account identifier 730 secured thereto in a manner similar to how account identifier 30 is secured to transaction card 10, as described above with respect to FIG. 1. Account identifier 730 includes one or more of a one-dimensional bar code, a two-dimensional bar code, a QR code, a magnetic strip, a smart chip or other electronic device, a radio frequency identification (RFID) device, or another suitable identifier readily machine readable by a POS terminal.

In one embodiment, where account identifier 730 is machine readable, a human-readable account identifier 731 is also included and readable by a bearer of transaction card 710 such that transaction card 710 can be used when a machine configured to read transaction card 710 is not present (e.g., when using transaction card 710 to make a purchase on a website). For example, human-readable account identifier 731 includes a predetermined account number including a character string, referencing a specific monetary account or record of value tracked in remote database 206 (FIG. 19), similar to that described above with respect to FIG. 1, that is maintained on a database, other electronic or manual record-keeping system, or, in the case of “smart cards” for example, on a chip or other electronic device on/in transaction card 710 itself including a number or letter string identifying the associated account or record.

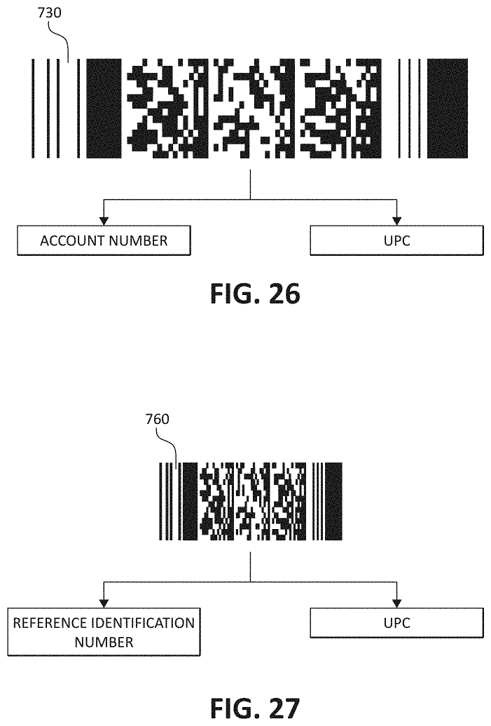

Account identifier 730 is coded to be readable via a machine, e.g., a point-of-sale scanning device, and includes a coded version of all or at least a portion of human-readable account identifier 731. In one example, as schematically illustrated in FIG. 26, account identifier 730 includes a Universal Product Code (UPC), for example, preceding or following the account number, identifying the details of what type or style of transaction card 710 is associated therewith and is, in one example, not associated with identifying the particular monetary account associated with the particular transaction card 710.

In one example, transaction card 710 additionally includes a human-readable access code 733, which acts a personal identification number (PIN) for the card or other check access number and/or letter sequence checked against the account identifier 731 before allowing activation of transaction card 710, as will be apparent to those of skill in the art upon reading the present application.

Security panel 740 is applied to transaction card 710 over account identifier 730, such that transaction card 710 and security panel 740 collectively define a transaction card product 732. Security panel 740 not only hides account identifier 730 from view, but, in one embodiment, takes any one of a variety of forms configured to provide visual indication of any tampering with security panel 740, such as that described above for security panel 40. As illustrated, in one example, security panel 740 is detachably adhered to transaction card 710, such that security panel 740 is adhered directly to rear surface 722 over account identifier 730 (see FIG. 23 as compared to FIG. 25) of transaction card 710.

In the embodiment illustrated in FIGS. 23-25, security panel 740 is a residue or a non-residue security label panel 740 including a transparent panel 742, which defines an interior surface 744 and an exterior surface 746 opposite interior surface 744, and an opaque adhesive layer 748 applied to interior surface 744. Security panel 740 is configured to be substantially and uniformly opaque when initially applied to transaction card 710, but when pulled away from transaction card 710, portions of opaque adhesive layer 748 are configured to pull away and/or contract in a predefined pattern. In this manner, as a part of security panel 740 is pulled from transaction card 710, portions of opaque adhesive layer 748 transition from opaque to transparent under the peeling forces imparted, leaving transparent portions 750 of security panel 740 behind. In one embodiment, the predefined pattern is one or more words, such as including the term “VOID,” however, other words, numbers, patterns, or other markings are also contemplated, as will be apparent to those of skill in the art upon reading the present application. In general, any attempted reapplication of security panel 740 to transaction card 710 does not alter the predefined patterns created upon peeling, such that the transparent portions of security panel 740 remain.

In one embodiment, an activation code 760, for example, similar to activation code 60 (FIG. 3), is printed or otherwise fixedly secured, e.g., embossing, etc., on exterior surface 746 of security panel 740. In one embodiment, activation code 760 is machine readable including one or more of a one-dimensional bar code, a two-dimensional bar code, a QR code, a magnetic strip, a smart chip or other electronic device, a radio frequency identification (RFID) device, or another suitable identifier readily machine readable by a POS terminal. Where activation code 760 is machine readable, in one example, a human-readable activation code 761 is also included and readable by a bearer of transaction card 710, such that transaction card 710 can be used when a machine configured to read transaction card 710 is not present (e.g., when using transaction card 710 to make a purchase on a web site).

In one embodiment, activation code 760 is not linked to the specific account or record in remote database 206 (FIG. 19) identified by account identifier 730, and therefore is not unique to the individual transaction card 710. In another embodiment, activation code 760 is unique to the individual transaction card 710 and is indirectly linked to a monetary account or record thereto, for instance, by including a predetermined reference identification (RID) number including a character string, referencing a database. The RID number indirectly associates the activation code 760 with the specific monetary account or record of value maintained in remote database 206 as identified by account identifier 730. However, in one example, activation code 760 is indirectly linked to the account number, that is, is characterized by non-inclusion of the actual account number or any portion thereof, such that one reading activation code 760 or human-readable activation code 761 generally cannot determine the identity of the specific monetary account or record linked to transaction card 710 without having reference to the remote database 206.

In one embodiment, remote database 206 includes a link, such as a listing or other record, association RID number with the account number. In this manner, during processing matching activation code 760 or 762 to the account number of account identifier 730 or 731 can serve as a cross-check to prevent tampering, while still not having the actual account number visible on any portion of transaction product 732 before removal of security panel 740 from transaction card 710.

Where activation code 760 is machine readable, in one example, a human-readable activation code 761 is also included and readable by a bearer of transaction card 710 such that transaction card 710 can be used when a machine configured to read transaction card 710 is not present (e.g., when using transaction card 710 to make a purchase on a website). For example, human-readable account identifier 761 includes the RID number. In one example, as schematically illustrated in FIG. 27, where activation code 760 is a machine-readable activation code 760 includes the RID number and additionally includes the Universal Product Code (UPC) identifying the details of what type or style of transaction card 710 is associated therewith, that may match the UPC included in account identifier 730. In this manner, activation code 760 is useful for inventory and tracking of similar transaction cards via the UPC, but is unique for individual check or tracking of the specific transaction card via the RID number. In one embodiment, RID number is characterized as not being configured for use in redemption of transaction card 710.

As described above, transaction card product 732 provides two machine-readable codes, that is account identifier 730 and activation code 760, used in activating transaction card 710 in a multiple-stage process similar to that described in detail above for transaction card 10. In general, during use, activation code 760 is scanned or otherwise entered into POS terminal, in a first stage of activation, with a prompt or automatically prompting the POS terminal to begin a sequence for activating a transaction card 710. After activation code 760 is entered into POS terminal, security panel 740 is peeled from transaction card 710 to reveal the second code, in this case, account identifier 730 on transaction card.

As illustrated in FIGS. 24 and 25, as portions of security panel 740 are peeled away from transaction card 710, opaque adhesive layer 748 is redistributed or removed leaving transparent panel 742 unobstructed and producing transparent portions 750 thereof, such as text or other graphics, scattered across at least about 30%, and, in one example, at least about 40%, of the surface area of peeled away portions of security panel 740. Since, in one embodiment, activation code 760 is printed atop security panel 40, activation code 760 itself is not destroyed or impacted upon peeling security panel 40. However, the creation of the transparent portions 750 around the void areas of activation code 760, creates readability noise in the form of a non-uniform background for activation code 760, as best illustrated in FIG. 25 around activation code 760, which generally destroys the ability for POS terminal or other machine to scan or otherwise read activation code 760. In one embodiment, activation code 760 may be printed to security panel 740 in a manner that does at least partially impact or destroy activation code 760 itself, thereby destroying readability thereof, for example, to be printed below transparent panel 742. Since activation code 760 is destroyed upon removal thereof to expose account identifier 730, transaction product 732 provides similar security assurances as described above with other transaction products according to the present invention.

In one embodiment, transaction card 710 is activated in an activation process similar to activation process 180 of FIG. 18, where, between operations 192 and 194 and/or as part of operation 194, activation code 760 is compared to account identifier 762 as an additional check for possible tampering with transaction card product 732. More specifically, before completing activation of transaction card 710 at 194, account records and cross-references in remote database 206 are referenced to determine what account number is indirectly associated with activation code 760. That account number is then compared to the account number of account identifier 730 to verify that the two codes match and have not been tampered with in that manner.

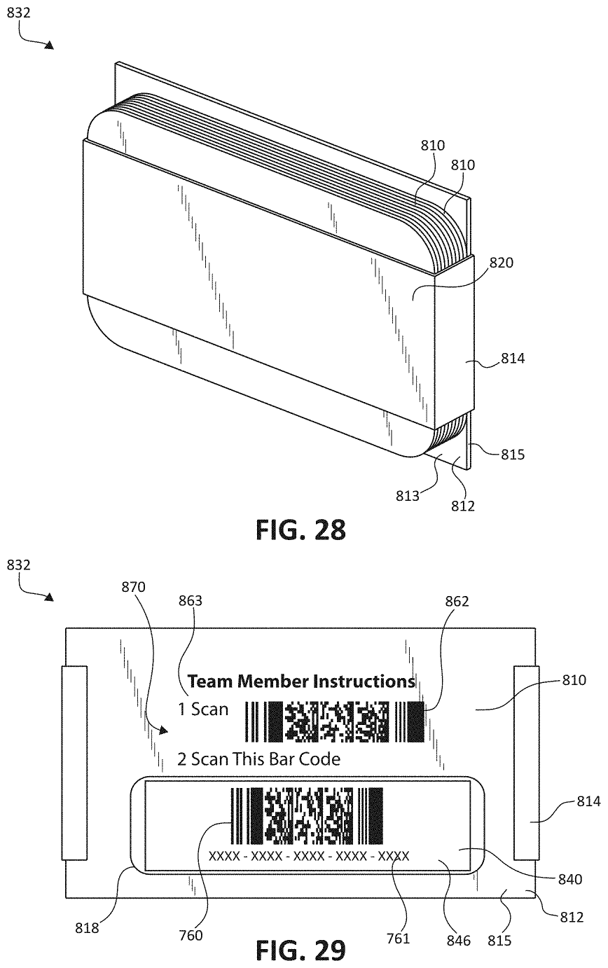

FIGS. 28-31 illustrate a transaction card product 832 including a plurality of transaction cards 810 each being similar to transaction cards 10 and/or 710, with like reference numerals indicating like parts, except where specifically differentiated herein, according to one embodiment of the present invention. Referring to FIG. 28, transaction card product 832 includes a package such as a card carrier 814 configured to maintain all of the plurality of transaction cards 810 together, for example, in one stack, as part of transaction card product 832. Card carrier 814 includes a backer panel 812 and securely maintains the plurality of transaction cards 810 to backer panel 812 via a wrap or band 820 as illustrated, or as part of an enclosed box, plastic wrap, plastic shell, shrink wrap, or other suitable structure as will be apparent to those of skill in the art upon reading the present application.

In one embodiment, each of the plurality of transaction cards 810 includes account identifier 730 secured thereto in a manner similar to how account identifier 30 is secured to transaction card 10, as described above with respect to FIG. 1. In one embodiment, where account identifier 730 is machine readable, a human-readable account identifier 731 is also included on each of the plurality of transaction cards 810. In one example, each of the plurality of transaction cards 810 additionally includes a human-readable access code 733, which acts a personal identification number (PIN) for the card or other check access number and/or letter sequence checked against the account identifier 731 before allowing activation of transaction card 710, as will be apparent to those of skill in the art upon reading the present application.

In one example, backer panel 812 defines a front surface 813 and an opposing back surface 815 and includes an aperture 818 for exposing therethrough the back of the one of the plurality of transaction cards 810 closest to backer panel 812 to expose account identifier 731, human-readable account identifier 731, and/or human-readable access code 733 therethrough. In one example, backer panel 812 or other portion of transaction product 832, such as one of the plurality of transaction cards 810, includes instructional indicia 870 providing team members with instructions for how to process transaction product 832 to activate all of the plurality of transaction cards 810 included therein. In another embodiment, aperture 818 is replaced by a label (not shown) adhered to backer panel 812 and including a reproduction of account identifier 731, human-readable account identifier 731, and/or human-readable access code 733 of one of the plurality of transaction cards 810.

In one example, transaction product 832 includes, such as, includes on one of the plurality of transaction cards 810, backer panel 812, or the label (not shown) thereon, a multipack code 860 for scanning at the POS terminal during card activation. Multipack code 860 is machine readable including one or more of a one-dimensional bar code, a two-dimensional bar code, a QR code, a magnetic strip, a smart chip or other electronic device, a radio frequency identification (RFID) device, or another suitable identifier readily machine readable by a POS terminal. In one embodiment, multipack code 860 includes information informing the POS terminal that it is going to be activating a plurality of transaction cards 810 included in transaction product 832 at one time such that POS terminal runs a slightly different activation process as compared to activating one transaction card at a time, as will be apparent to those of skill in the art.

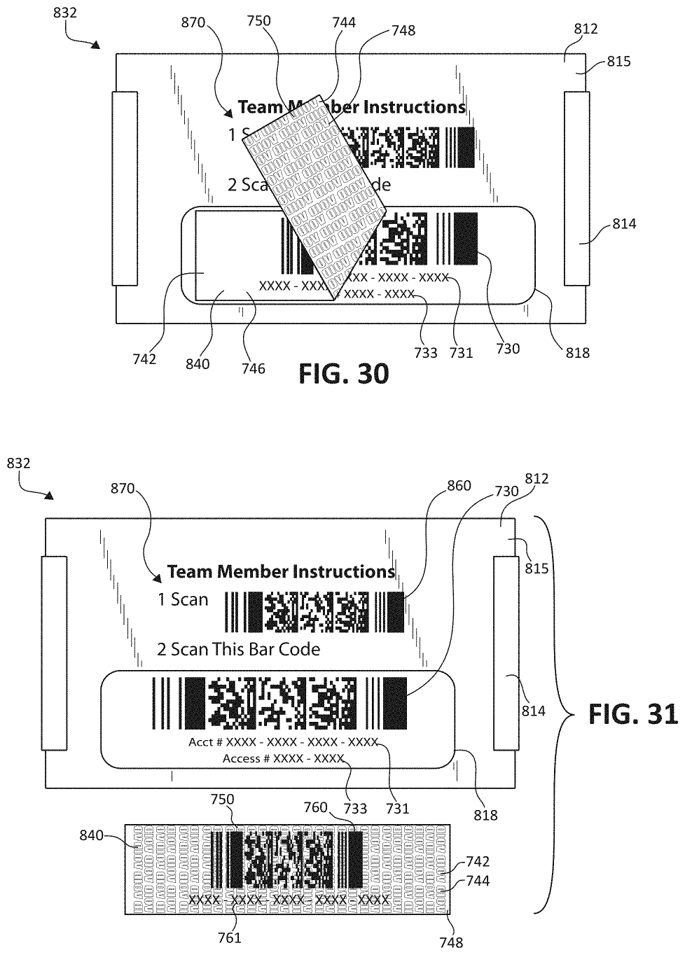

Security panel 840 is applied over account identifier 730, to hide account identifier 730 from view and to provide visual indication of any tampering with security panel 840, such as that described above for security panel 740. As illustrated, in one example, security panel 840 is detachably adhered to the back one of the plurality of transaction cards 810, such that security panel 840 is adhered directly over account identifier 730 (see FIG. 29 as compared to FIGS. 30 and 31) of transaction card 810. In one embodiment, where account identifier 730 is otherwise reproduced on backer card 812 or a label (not shown) on backer card 812.

In the embodiment illustrated in FIGS. 28-31, security panel 840 is a residue or a non-residue security label 840 including a transparent panel 742, which defines an interior surface 744 and an exterior surface 746 opposite interior surface 744, and an opaque adhesive layer 748 applied to interior surface 744 similar to security label 740. Security panel 840 is configured to initially be substantially and uniformly opaque, but when pulled away from transaction card 810 or other corresponding portion of transaction product 832, portions of opaque adhesive layer 748 are configured to pull away and/or contract in a predefined pattern. In this manner, as a part of security panel 840 is pulled from transaction card 810, portions of opaque adhesive layer 748 transition from opaque to transparent under the peeling forces imparted, leaving transparent portions 750 of security panel 840 behind. In general, any reapplication of security panel 840 to transaction card 810 or other portion of transaction product 832 does not alter the predefined patterns, such that the transparent portions of security panel 840, created when security panel 840 was pulled remain upon any reapplication of security panel 840 to transaction product 832.

In one embodiment, an activation code 760, is printed or otherwise fixedly secured, e.g., embossing, etc., on exterior surface 746 of security panel 840. Where activation code 760 is machine readable, in one example, a human-readable activation code 761 is also included and readable by a bearer of transaction card 810, and can be used when a machine configured to read transaction card 810 is not present (e.g., when using transaction card 810 to make a purchase on a web site).

Transaction card product 810 is processed for sale in a similar manner as transaction card product 710 other than the addition of multipack code 860 being scanned before activation code 760 and the activation of the plurality of transaction cards 810 rather than just one transaction card 710, as will be apparent to those of skill in the art upon reading the current application. During processing security panel 840 functions similarly to security panel 740 to first present activation code 740, but to destroy readability of activation code 740 when pulled from transaction product 832 to reveal account identifier 730.

Other embodiments of forming a transaction card product including transaction card 10 in a manner deterring third-party fraudulent interaction with account identifier 30 or other identifier associated with the account are also contemplated. In addition, features and portions of transaction products 32, 580, 80, 150, 380, 732, and 832 can be interchanged with each other in manners that will be apparent to those of skill in the art upon reading the present application.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium and, in one example, is a non-transitory computer readable storage medium or database. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wired, optical fiber cable, infrared, etc., or any suitable combination of the foregoing. Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made through an external computer (for example, through the Internet using an Internet Service Provider).

The flowchart and block diagram in the above figures illustrate the architecture, functionality, and operation of possible implementations of systems, methods and computer program products according to various embodiments of the present invention. In this regard, each block in the flowcharts and block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the invention has been described with respect to particular embodiments, such embodiments are meant for illustrative purposes only and should not be considered to limit the invention. Various alternatives and changes will be apparent to those of ordinary skill in the art upon reading this application. Other modifications within the scope of the invention and its various embodiments will be apparent to those of ordinary skill.

What is claimed is:

1. A transaction card product comprising:
a transaction card;
an account identifier uniquely linking the transaction card to a remote account having a balance value available for redemption toward one or more of goods or services;
a security panel coupled to the transaction card and substantially entirely covering the account identifier, wherein the security panel is configured to be at least partially removed from a remainder of the transaction card product to permit access to the account identifier; and
an activation code having data therein to prompt a point-of-sale terminal to begin a transaction card activation process, the activation code having a first portion directly secured to and extending over the security panel, wherein the activation code is characterized by an absence of any data directly identifying the remote account.

2. The transaction card product of claim 1, wherein a second portion of the activation code is secured to the transaction card product outside the outermost perimeter of the security panel.

3. The transaction card product of claim 1, wherein a second portion of the activation code is directly secured to the transaction card.

4. The transaction card product of claim 1, wherein a second portion of the activation code is directly secured to the transaction card product outside the outermost perimeter of the security panel.

5. The transaction card product of claim 1, wherein the at least partial removal of the security panel from the remainder of the transaction card product renders the activation code unreadable.

6. The transaction card product of claim 1, wherein:
the security panel is configured such that as the security panel is peeled away from the transaction card to reveal the account identifier, the security panel transitions from a first state to a second state,
in the first state, the activation code is machine readable on the security panel, and
in the second state, the activation code is characters as not being machine readable on the security panel.

7. The transaction card product of claim 1, wherein the security panel is adhered directly to the transaction card, and removal of the security code from the transaction card destroys readability of the activation code.

8. The transaction card product of claim 7, wherein removal of the security panel dissects the activation code into at least two portions such that only one of the at least two portions remain coupled to the transaction card, and neither of the at least two portions of the activation code alone contains sufficient data to prompt the point-of-sale terminal to begin the transaction card activation process.

10. The transaction card product of claim 1, the account identifier includes an account number and a universal product code, and the activation code includes a reference identification number and the universal product code, where in the reference identification number is associated with the account number only via records maintained in a remote database.

11. The transaction card product of claim 1, wherein:
the account identifier is a first account identifier configured for activation of the transaction card and characterized by being unusable for redemption of the balance value,
the transaction card product further comprises a second account identifier that differs from the first account identifier and uniquely links the transaction card to the remote account,
the second account identifier is substantially permanently secured to the transaction card and is configured for use in redeeming the balance value, and
the second account identifier is hidden from view even after at least partial removal of the security panel from the remainder of the transaction card product to permit access to the first account identifier.

12. The transaction card product of claim 11, further comprising:
a package separate from and substantially entirely enclosing the transaction card; wherein the package includes the activation code, the security panel, and the first account identifier.

13. The transaction card product of claim 1, further comprising:
a card package, the card package including:
a first package section,
a second package section opposite to and coupled with the first package section to secure the transaction card between the first package section and the second package section, wherein the security panel is formed by the second package section and is readily removable from a remainder of the second package section via perforations defined on the second package section substantially separating the security panel from the remainder of the second package section, and the second package is configured such that removal of the security panel via the perforations destroys readability of the activation code, and the activation code is indirectly coupled with the transaction card via the card package.

14. The transaction card product of claim 1, wherein the account identifier is a first account identifier, and the transaction card product further comprises:
a second account identifier uniquely identifying the remote account linked to the transaction card and being configured for use in facilitating redemption of the balance value toward one or more of goods or services,
wherein:
the second account identifier is substantially permanently secured to the transaction card and is different than the first account identifier, and
the first account identifier is not configured for use in redeeming the balance value.

15. A method of activating a transaction card linked to a remote account having a balance value available for redemption toward one or more of goods and services, the transaction card being part of a transaction card product, and the method comprising:
using a point-of-sale terminal to read an activation code from the transaction card product in a manner automatically prompting the point-of-sale terminal to initiate a card activation process, wherein the activation code is characterized by an absence of any data directly identifying the remote account;
at least partially removing a security panel from the transaction card product to substantially simultaneously destroy readability of the activation code and to reveal an account identifier previously hidden from view by the security panel, wherein the account identifier identifies the remote account stored in a database and linked to the transaction card;
using the point-of-sale terminal to read the account identifier from the transaction card product and activating the remote account identified by the account identifier to allow the balance value to be redeemed toward one or more of goods and services.

16. The method of claim 15, wherein the activation code is not configured for use in redeeming the balance value.

17. The method of claim 16, wherein the activation code is unique to the transaction card and is associated to the remote account indirectly via records stored in the database.

18. The method of claim 17, further comprising comparing the activation code against the records stored in the database to verify that the activation code indirectly identifies the same remote account that is directly identified by the account identifier before activating the remote account.

19. The method of claim 16, further comprising:
after activating the remote account, identifying the remote account by reading the account identifier; and
redeeming the balance value of the remote account identified by reading the account identifier toward one or more of the goods and the services, wherein the activation code is not configured for use in redeeming the balance value.

20. The method of claim 15, wherein the transaction card product includes a package, the package includes the activation code and the security panel, the security panel being positioned to cover the account identifier, the activation code being printed to the package in a manner extending over the security panel and beyond at least one outer edge of the security panel, and at least partially removing the security panel from the transaction card product destroys readability of the activation code by dissecting the activation code into at least two parts, one of the at least two parts being removed from the remainder of the transaction card product with the security panel.

21. The method of claim 15, wherein the account identifier is a package account identifier included on a package substantially enclosing the transaction card, the transaction card includes a card account identifier that differs from the package account identifier and identifies the remote account linked to the transaction card, and the method further includes scanning the card account identifier to redeem the balance value after activating the remote account.

22. The method of claim 15, wherein the package account identifier is not configured for use in redeeming the balance value.

23. The method of claim 15, further comprising prior to using the point-of-sale terminal to read the activation code from the transaction card product in a manner automatically prompting the point-of-sale terminal to initiate a card activation process:
attempting to activate a compromised transaction card product, which is substantially identical to the transaction card product other than the account identifier of the compromised transaction product identifying a different remote account that the account identifier of the transaction product and having a compromised activation code that has been compromised via attempted tampering, by scanning the compromised activation code,
failing to automatically initiate the card activation process upon scanning the compromised activation code, and
prompting selection of the transaction card product in lieu of the compromised transaction card product.
